(19) United States
(12) Patent Application Publication
(10) Pub. No.: US 2023/0200410 A1
(43) Pub. Date: Jun. 29, 2023

(54) ANIMAL FEED OR FEED PRODUCT INCLUDING BEETROOT POWDER

(71) Applicant: CAN TECHNOLOGIES, INC., Wayzata, MN (US)

(72) Inventors: David A. COOK, Coon Rapids, MN (US); Moniek VAN DEN BOSCH, Sint Anthonis (NL)

(73) Assignee: CAN TECHNOLOGIES, INC., Wayzata, MN (US)

(21) Appl. No.: 18/000,140

(22) PCT Filed: May 6, 2021
(86) PCT No.: PCT/US2021/031077

§ 371 Date: Nov. 29, 2022

Related U.S. Application Data
(60) Provisional application No. 63/031,829, filed on May 29, 2020.

(51) Int. Cl. A23K 10/30; A23K 50/30

(52) U.S. Cl. CPC A23K 10/30; A23K 50/30

(57) ABSTRACT

Various aspects relate to an animal feed or feed product for forming the animal feed including beetroot powder. The feed product includes a premix, a concentrate, a base mix, a supplement, a top dress, or a combination thereof. The beetroot powder is 0.001 wt % to 5 wt % of the animal feed. Various aspects relate to methods of feeding the animal feed to an animal.

### CROSS-REFERENCE TO RELATED APPLICATIONS

This application claims the benefit of U.S. Provisional Application No. 63/031,829, filed May 29, 2020, and entitled “ANIMAL FEED OR FEED PRODUCT INCLUDING BEETROOT POWDER,” which is incorporated by referenced herein in its entirety.

### BACKGROUND

Restricted blood flow to a sow's uterus reduces fetal development and survival. Although placental blood flow increases significantly as pregnancy progresses, uterine blood flow per fetus decreases when litter size increases, which might explain why piglets from larger litters are lighter at birth. This suggests that a larger blood flow (e.g., by improved vasculogenesis/angiogenesis, better placental development or otherwise), especially in the last stages of gestation when fetal growth increases tremendously, could stimulate piglet birth weight and therefore piglet survival. In addition, a larger blood flow towards piglets during farrowing could potentially decrease the risk for asphyxiation and might therefore decrease stillbirth and increase vitality at birth. Sows become fatigued during the farrowing process and the time from umbilical detachment to exiting the sow can lead to hypoxia and either weakened or still-born piglets. Intra-partum asphyxiation, when not severe enough to result in death, can reduce vitality of piglets right after birth, which also increases the risk for early pre-weaning mortality.

Dietary nitrate is a nitric oxide (NO) precursor. Nitric oxide is an endothelium-derived relaxing factor leading to vasodilation and can play a role in regulating placental-fetal blood flow and transfer of nutrients and O₂ from mother to fetus. One common source of nitrate is calcium nitrate; however, this material has limited approval for use in animals in many countries.

### SUMMARY OF THE INVENTION

Various aspects provide a composition that is an animal feed or a feed product for forming the animal feed. The composition includes beetroot powder. In various aspects, the feed product includes a premix, a concentrate, a base mix, a supplement, a top dress, or a combination thereof. In various aspects, the beetroot powder can be 0.001 wt % to 5 wt % of the animal feed.

Various aspects provide a feed product that is a premix, a base mix, a concentrate, a supplement, or a top dress, for forming an animal feed for at least one of a gestation or lactation phase of a pig. The feed product includes beetroot powder that is 0.1 wt % to 30 wt % of the feed product. The feed product is formulated to form the animal feed by combining with a base animal feed such that the feed product is 10 wt % or less of the animal feed.

Various aspects provide an animal feed for use in at least one of a gestation or lactation phase of a pig. The animal feed includes a base animal feed. The animal feed also includes beetroot power that is 0.001 wt % to 0.5 wt % of the animal feed.

Various aspects provide a method of feeding an animal. The method includes feeding the animal beetroot powder. In various aspects, feeding the animal beetroot powder includes adding the beetroot powder to animal feed for ingestion by the animal, adding the beetroot powder to water for drinking by the animal, or a combination thereof. In various aspects, feeding the animal beetroot powder includes feeding the animal an animal feed that is 0.001 wt % to 5 wt % beetroot powder. In various aspects, feeding the animal beetroot powder includes feeding the animal the animal feed including beetroot powder described herein.

Various aspects provide a method of feeding a pig. The method includes feeding the pig an animal feed during at least one of a gestation or lactation phase of the animal. The animal feed includes a base animal feed and beetroot powder. The beetroot powder is 0.001 wt % to 5 wt % of the animal feed. The method decreases pre-weaning mortality of an offspring of the animal, increases livability of an offspring of the animal, increases daily average weight gain of an offspring of the animal, decreases the number of stillborn offspring of the animal, or a combination thereof, as compared to a corresponding method using animal feed that includes less or none of the beetroot powder.

Various aspects provide a method of making the animal feed described herein. The method includes combining the feed product described herein with a base animal feed, to form the animal feed.

Various aspects provide a method of making an animal feed. The method includes combining a feed product with a base animal feed, to form an animal feed. The feed product includes beetroot powder that is about 0.001 wt % to 30 wt % of the feed product. The beetroot powder is 0.001 wt % to 5 wt % of the animal feed.

Various embodiments of the composition and method of using the same have certain advantages, as compared to compositions including less or no beetroot. For example, various embodiments of the present invention provide enhanced nitrate to the animal using a natural source of nitrate (i.e., beetroot). Various embodiments of the present invention provide improvements in pre-weaning mortality, livability, average daily weight gain, average weight at weaning, the number of stillborn offspring, birth weight, vitality, or a combination thereof, of the offspring of a mother fed the composition shortly before birth of the offspring, during the lactation period, or a combination thereof. Various embodiments of the present invention provide enhanced oxygenation of the blood of the offspring by enhancing blood flow to the uterus and/or via enhanced ability of the offspring to combat stress (e.g., heat stress and/or other stresses). Various embodiments provide improved digestion of decreased digestive problems in the mother as result of increased blood flow to the gut, improved meat color due to increased blood flow to the muscles, decreased issued like ear necrosis by improving blood flow to the ears, better color (e.g., pinkness) of the skin due to enhanced blood flow, or a combination thereof. In various embodiments, the nitrate in the beetroot used in compositions and methods of the present invention is more bioavailable than the nitrate in calcium nitrate-based compositions.

Various embodiments of the present invention provide similar or greater improvements in pre-weaning mortality, livability, average daily weight gain, average weight at weaning, the number of stillborn offspring, birth weight, vitality, or a combination thereof, using a much lower level of nitrate than used in similar calcium nitrate-containing compositions, potentially due to the presence of other components of the beetroot fed to the mother acting to support enhanced vitality of the offspring. In various embodiments, a particular weight percent of beetroot powder in the animal feed causes a greater improvement in pre-weaning mortality, livability, average daily weight gain, average weight at weaning, the number of stillborn offspring, birth weight, vitality, or a combination thereof, as compared to a similar animal feed having the same weight percent of calcium nitrate in place of the beetroot powder.

### BRIEF DESCRIPTION OF THE FIGURES

The drawings illustrate generally, by way of example, but not by way of limitation, various embodiments of the present invention.

FIG. 1A illustrates the incidence of stillbirth for various feed compositions, in accordance with various aspects of the present invention.

FIG. 1B illustrates the individual piglet birth weight for sows fed various feed compositions, in accordance with various aspects of the present invention.

FIG. 2 illustrates the average daily weight gain for the litter from sows fed various feeds, in accordance with various aspects of the present invention.

FIG. 3A illustrates livability of piglets from sows feed various feed compositions, in accordance with various aspects of the present invention.

FIG. 3B illustrates pre-weaning mortality of piglets from sows fed various feed compositions, in accordance with various aspects of the present invention.

FIG. 4 illustrates other components in red beetroot that may have an additive or interactive effect with nitrate, in accordance with various aspects of the present invention.

FIG. 5 illustrates the interaction between treatment and parity class for probability born alive, in accordance with various aspects of the present invention.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Composition Including Beetroot Powder.

Various aspects of the present invention provide a composition including beetroot powder. The composition is an animal feed, or a feed product for forming the animal feed. The feed product can be designed to be mixed with another composition, such as a base animal feed, to form the animal feed.

The animal feed can be formulation for use in any suitable life stage of the animal, such as during at least one of breeding, gestation, or a lactation phase of a female animal or pregnant female animal. The animal can be a ruminant, pig, avian species (e.g., chicken, duck, or turkey), horse, aquaculture animal, companion animal, or wild game. The animal can be a pig, such as a domestic pig, Sus scrofa domesticus. The domestic pig can be any suitable breed of domestic pig described herein.

The beetroot powder can form any suitable proportion of the animal feed. For example, the beetroot powder can be 0.001 wt % to 5 wt % of the animal feed, 0.01 wt % to 0.5 wt %, 0.02 wt % to 0.2 wt %, or 0.001 wt % or more, or less than, equal to, or greater than 0.005 wt %, 0.01, 0.02, 0.04, 0.06, 0.08, 0.1, 0.15, 0.2, 0.25, 0.3, 0.35, 0.4, 0.45, 0.5, 0.6, 0.7, 0.8, 0.9, 1, 1.2, 1.4, 1.6, 1.8, 2, 2.5, 3, 3.5, 4, 4.5 wt %, or 5 wt % or less.

The animal feed can be a complete feed. A complete feed is a nutritionally adequate feed for animals that is compounded to be fed as the sole ration and is capable of maintaining life and/or promoting production without any additional substance being consumed except water. Complete feeds are compounded mixtures containing all the nutrients of concentrates plus various energy sources such as grains, some fat, and the like. In addition, certain major minerals may be added. An example of a complete feed can include cottonseed meal, rapeseed and canola meals, meat and bone meal, wheat middlings, soybean meal, corn gluten meal, distillers grains, blood meal, salt, macro-minerals, minerals, vitamins, and combinations thereof.

Nitrate can form any suitable proportion of the beetroot powder, such as 0.05 wt % to 3 wt % of the beetroot powder, 0.4 wt % to 1 wt % of the beetroot powder, 0.05 wt % or more, or less than, equal to, or greater than 0.1 wt %, 0.2, 0.4, 0.5, 0.6, 0.7, 0.8, 0.9, 1, 1.2, 1.4, 1.6, 1.8, 2, 2.2, 2.4, 2.6, 2.8 wt %, or 3 wt % or less.

Nitrate can form any suitable proportion of the animal feed, such as 0.001 g/kg to 1 g/kg, 0.01 g/kg to 0.5 g/kg, or 0.001 g/kg or more, or less than, equal to, or greater than 0.005 g/kg, 0.01, 0.05, 0.1, 0.2, 0.3, 0.4, 0.5, 0.6, 0.8 g/kg, or 1 g/kg or more. Nitrogen from nitrate in the animal feed can be any suitable proportion of the animal feed, such as 0.001 g/kg to 0.2 g/kg, 0.01 g/kg to 0.1 g/kg, 0.001 g/kg or more, or less than, equal to, or greater than 0.004 g/kg, 0.006, 0.008, 0.01, 0.02, 0.03, 0.04, 0.05, 0.06, 0.07, 0.08, 0.09, 0.1, 0.15 g/kg, or 0.2 g/kg or less.

The feed product can be any suitable feed product designed for mixing with another composition, such as a base animal feed, to form the animal feed. The feed product can include a premix, a concentrate, a base mix, a supplement, a top dress, or a combination thereof.

A base animal feed can be a commercially available feed or other animal feed. A base animal feed can refer to a ration that contains any of the various cereal grains, their by-products, and other sources of primary nutrition (e.g., fat, fiber, and protein) such as barley, blood meal, bone meal, Brewer's grain, corn grain, corn gluten meal, corn gluten feed, cottonseed (e.g., whole or meal), distiller's grain, fish meal, hominy, feather meal, molasses, peanut skins, soybeans (e.g., whole or meal), tallow, wheat (e.g., whole, bran or middlings), or a combination thereof.

A premix is a composition that can include vitamins, minerals, appropriate medications, carriers, and combinations thereof, and are typically less than 1% of the diet but can be higher. The carrier can increase bulk to improve distribution in compounding to prepare a more complete feed material. Examples of carriers can include soy mill run, rice bran, and similar edible plant by-products. Such premixes can be used to formulate concentrates and complete feeds.

A concentrate is a composition that can include high-protein feed components and can also include vitamins, minerals, appropriate medications, and combinations thereof. A concentrate is typically 5-40% of the diet but can be higher or lower. A concentrate can include additives. Concentrates can be used to make complete feeds by adding available grains or other energy sources. An additive is an ingredient or a chemical preparation or combination of ingredients which is added to the basic feed to fulfill a specific need. It is usually used in micro quantities and may have no nutritional value but is added to the feed to improve its quality and efficacy. Feed additives include, but not limited to, acidifiers, antioxidants, aromatics, deodorizing agents, flavor enhancers, mold inhibitors, pellet binders, preservatives, sweeteners, toxin binders, and the like.

A base mix can be similar to a supplement but contain only part of the animal's protein requirements, so is generally used with high protein ingredients and grain (e.g., ground grain and protein source, such as soybean meal) to form the animal feed. A base mix can include a mixture of one or more macro-mineral sources and one or more micro-ingredient sources such as vitamin premixes, trace mineral premixes, essential amino acids and feed additives, that when mixed with sources of protein and energy form a complete feed.

A supplement is a feed ingredient or a chemical preparation or combination of feed ingredients intended to supply the deficiencies in an animal feed and/or improve the nutritive balance or performance of the animal feed. A top dress is a supplement added at specific time intervals to the animal ration to provide a specific supplement or supplements over a period of time that makes it inconvenient or difficult to include in complete feed.

The feed product, such as a premix, a concentrate, a supplement, a top dress, or a base mix, can be formulated such that the feed product is any suitable proportion of the animal feed, such as 30 wt % or less of the animal feed, 10 wt % or less, 0.1 wt % to 30 wt %, 1 wt % to 30 wt %, 1 to 15 wt %, 1 wt % to 5 wt %, 15 wt % to 30 wt %, or 0.1 wt % or more, or less than, equal to, or greater than 1 wt %, 2, 3, 4, 5, 6, 8, 10, 12, 14, 16, 18, 20, 22, 24, 26, 28 wt %, or 30 wt % or less of the animal feed.

Beetroot powder can form any suitable proportion of the feed product, such as the premix, base mix, concentrate, supplement, top dress, or a combination thereof, such as 0.001 wt % to 30 wt % of the feed product, 0.4 wt % to 15 wt %, 0.8 wt % to 10 wt %, or 0.001 wt % or more, or less than, equal to, or greater than 0.005 wt %, 0.01, 0.05, 0.1, 0.15, 0.2, 0.3, 0.4, 0.5, 0.6, 0.7, 0.8, 0.9, 1, 1.5, 2, 2.5, 3, 4, 5, 6, 7, 8, 9, 10, 11, 12, 13, 14, 15, 16, 18, 20, 22, 24, 26, 28 wt %, or 30 wt % or less of the feed product. The feed product can include vitamins, trace minerals, edible plant materials, grain, corn, soy, rice, wheat, or a combination thereof. Nitrate in the feed product can be any suitable amount, such as 0.01 g/kg to 2.0 g/kg, 0.01 g/kg to 1.0 g/kg, or 0.01 g/kg or more, or less than, equal to, or greater than 0.02, 0.03, 0.04, 0.06, 0.08, 0.1, 0.15, 0.2, 0.25, 0.3, 0.35, 0.4, 0.5, 0.6, 0.7, 0.8, 0.9, 1, 1.2, 1.4, 1.6, 1.8 g/kg, or 2.0 g/kg or less. Nitrogen from nitrate in the feed product can be any suitable amount, such as 0.01 g/kg to 0.5 g/kg, 0.01 g/kg to 0.2 g/kg, or 0.01 g/kg or more, or less than, equal to, or greater than 0.02 g/kg, 0.03, 0.04, 0.05, 0.06, 0.07, 0.08, 0.09 g/kg, or 0.1 g/kg or less.

### Method of Feeding an Animal.

Various aspects of the present invention provide a method of feeding an animal. The method includes feeding the animal beetroot powder. In various aspects, the method can provide certain advantages to the animal as compared to a corresponding method using animal feed that includes less or none of the beetroot powder. For example, in various aspects, the method decreases pre-weaning mortality of an offspring of the animal, increases livability of an offspring of the animal, increases daily average weight gain of an offspring of the animal, decreases the number of stillborn offspring of the animal, increases birth weight of an offspring of the animal, increases vitality of an offspring of the animal, or a combination thereof, as compared to a corresponding method using animal feed that includes less or none of the beetroot powder.

The method can include any suitable method of feeding the beetroot powder to the animal. For example, the feeding of the beetroot powder can include adding the beetroot powder to animal feed for ingestion by the animal, adding the beetroot powder to water for drinking by the animal, or a combination thereof. Feeding the animal the beetroot powder can include feeding the animal an animal feed that is 0.001 wt % to 5 wt % beetroot powder (e.g., 0.01 wt % to 0.5 wt %, 0.02 wt % to 0.2 wt %, or 0.001 wt % or more, or less than, equal to, or greater than 0.005 wt %, 0.01, 0.02, 0.04, 0.06, 0.08, 0.1, 0.15, 0.2, 0.25, 0.3, 0.35, 0.4, 0.45, 0.5, 0.6, 0.7, 0.8, 0.9, 1, 1.2, 1.4, 1.6, 1.8, 2, 2.5, 3, 3.5, 4, 4.5 wt %, or 5 wt % or less). Feeding the animal the beetroot powder can include feeding the animal feed including beetroot powder described herein. In various aspects, the method can include combining the feed product described herein with a base animal feed to form the animal feed.

The method can include feeding the animal feed including beetroot powder to the animal (e.g., a pregnant animal) while the animal is in at least one of a breeding, gestation, or lactation phase. The method can include feeding the animal feed to the animal through at least farrowing of the animal. The method can include feeding the animal feed after farrowing and before weaning. The animal feed can be a daily feed ration that is fed to the animal on most days or on all days.

The animal can be a ruminant, pig, avian species (e.g., chicken, duck, or turkey), horse, aquaculture animal, companion animal, or wild game. The animal can be a pig, such as a domestic pig, Sus scrofa domesticus. The animal can be a pregnant sow. The pig can be any suitable type of pig, such as a breed of domestic pig including Aksai Black Pied, American Yorkshire, Angeln Saddleback, Appalachian English, Arapawa Island, Auckland Island Pig, Australian Yorkshire, Ba Xuyen, Babi Kampung, Bangur Pig, Bantu, Basque, Bazna, Beijing Black, Belarus Black Pied, Belgian Landrace, Bengali Brown Shannaj, Bentheim Black Pied, Berkshire, Bisaro, Black Canarian Pig, Black Slavonian, Breitovo, British Landrace, British Lop, British Saddleback, Bulgarian White, Cantonese, Celtic Pig, Chato Murciano, Chester White, Chiangmai Blackpig, Moodum Chiangmai, Creole Pig, Cumberland Pig, Czech Improved White, Danish Landrace, Danish Protest Pig, Dermantsi Pied, Dharane Kalo Sungur, Duroc, Dutch Landrace Pig, East Balkan Pig, Essex, Estonian Bacon, Fengjing Pig, Finnish Landrance, Forest Mountain, French Landrace, Gascon, German Landrace, Gloucestershire Old Spot, Grice, Guinea Hog, Göttingen Minipig, Hampshire, Hante, Hereford, Hezuo, Hogan Hog, Huntingdon Black Hog, Iberian, Italian Landrace, Japanese Landrace, Jeju Black Pig, Jinhua Pig, Juliana, Kakhetian, Kele Pig, Kemerovo, Korean Native Pig, Krskopolje, Kunekune, Lacombe, Large Black, Large Black-White, Large White, Latvian White, Leicoma, Li Yan Pig, Lincolnshire Curly-Coated Pig, Linderödssvin, Lithuanian Native, Lithuanian White, Livny, Malhado De Alcobaça, Mangalitsa, Meishan, Middle White, Minokawa Buta, Minzhu, Mong Cai, Mora Romagnola, Moura, Mukota, Mulefoot, Murom, Myrhorod, Neijiang, Nero Dei Nebrodi, Ningxiang, North Caucasian, North Siberian, Norwegian Landrace, Norwegian Yorkshire, Ossabaw Island, Oxford Sandy and Black, Pakchong 5, Philippine Native, Piétrain, Poland China, Red Wattle, Semirechensk, Siberian Black Pied, Small Black, Small White, Spots, Surabaya Babi, Swabian-Hall, Swedish Landrace, Taihu Pig, Tamworth, Thuoc Nhieu, Tibetan, Tokyo-X, Tsivilsk, Turopolje, Ukrainian Spotted Steppe, Ukrainian White Steppe, Urzhum, Vietnamese Potbelly, Welsh, Wessex Saddleback, West French White, Windsnyer, Wuzishan, Yanan, Yorkshire Blue and White, or a combination thereof.

Advantages flowing from the method are not limited to any particular mode of operation. In various aspects, the method can increase vasodilation of at least one of the placenta and the mammary glands of the animal. The vasodilation of the placenta can increase nutrients and oxygen to the placenta, thereby increasing nutrients and oxygen to a fetus of the animal and supporting uterine contractions to help reduce animal fatigue and farrowing time. The vasodilation of the mammary glands of the animal can increase milk production of the animal.

In various aspects, the method can decrease pre-weaning mortality of offspring of the animal, calculated as (dead offspring/(offspring born alive+added at fostering−removed at fostering))*100%, as compared to a corresponding method using animal feed that includes less or none of the beetroot powder. For example, the method can decrease pre-weaning mortality by 1% to 20%, 2% to 10%, or 1% or more, or less than, equal to, or greater than 2%, 3, 4, 5, 6, 7, 8, 9, 10, 11, 12, 13, 14, 15, 16, 17, 18, 19%, or 20% or less.

In various aspects, the method can increase livability of offspring of the animal, calculated as 1−((dead offspring+stillborn offspring)/(total offspring born+added at fostering−removed at fostering))*100%, as compared to a corresponding method using animal feed that includes less or none of the beetroot powder. For example, the method can increase livability of offspring of the animal by 1% to 20%, 3 to 15%, or 1% or more, or less than, equal to, or greater than 2%, 3, 4, 5, 6, 7, 8, 9, 10, 11, 12, 13, 14, 15, 16, 17, 18, 19%, or 20% or less.

In various aspects, the method can increase average daily weight gain of an offspring of the animal, as compared to a corresponding method using animal feed that includes less or none of the beetroot powder. For example, the method can increase average daily weight gain by 1% to 30%, 5% to 15%, or 1% or more, or less than, equal to, or greater than 2%, 3, 4, 5, 6, 7, 8, 9, 10, 11, 12, 13, 14, 15, 16, 18, 20, 22, 24, 26, 28%, or 30% or less.

In various aspects, the method can decrease the number of stillborn offspring of the animal, as compared to a corresponding method using animal feed that includes less or none of the beetroot powder. For example, the method can decrease the average number of stillborn offspring by 0.1% to 8%, 0.5% to 4%, or 0.1% or more, or less than, equal to, or greater than 0.2, 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.5, 5, 5.5, 6, 6.5, 7, 7.5%, or 8% or less.

In various aspects, the method can increase average weight at weaning of an offspring of the animal, as compared to a corresponding method using animal feed that includes less or none of the beetroot powder.

### Method of Making an Animal Feed.

Various aspects of the present invention provide a method of making the animal feed described herein. The method includes combining the feed product described herein with another composition, such as a base animal feed, to form the animal feed.

The method can include combining a feed product with a base animal feed, to for the animal feed. The feed product includes beetroot powder that is about 0.001 wt % to 30 wt % of the feed product. The beetroot powder is 0.001 wt % to 5% of the animal feed.

### Examples

Various embodiments of the present invention can be better understood by reference to the following Examples which are offered by way of illustration. The present invention is not limited to the Examples given herein.

### Materials and Methods

The beetroot used in these experiments was a red beetroot powder from Delacon, containing 0.4-1.0% of nitrate by weight. In comparison, calcium nitrate contains 63.1% of nitrate and is generally less expensive per kilogram. Although price and nitrate content differences are big, the potential for an alternative source of nitrate can be enormous—not only to solve livability problems, but also as a farm entry ticket to acquire new customers. Dosing used in the current trial will be 0.02% and 0.2% by weight. 0.2% of beetroot powder will provide 1% of nitrate which is a 60-fold lower compared to the optimal dose used when using calcium nitrate (0.12% by weight). It is, however, unknown if the dose should be the same for sows that are lower in productivity (assuming this is the case outside of Europe) and if there are other (unknown) components within the beetroot that can enhance the effect. Table 1 shows a comparison between calcium nitrate and beetroot powder.

TABLE 1
Comparison between CaNO₃ and Beetroot
powder in nitrate content.

| | Nitrate | Nitrate content | |
|---|---|---|---|
| | content | in feed | Comments |
| Calcium Nitrate | 63% | 0.12% by weight | |
| (current) | | | |
| Beetroot powder | 1.0% | 0.0002-0.002% | Low actives, but |
| | | by weight => | contains other |
| | | 600 to 60x lower | potential actives |

### Experimental Design.

This experiment was conducted at the Sow Innovation Center Iowa-Lactation unit. On May 17, 2019, 360 sows were randomly assigned to one of three treatments (n=120 per treatment). The trial was designed to test two levels of red beetroot powder on Livability and technical performance of sows and piglets. The red beetroot powder used was added at either 0.02% or 0.2% by weight of the completed feed as described in Table 2. Sows were blocked by parity and room and the response variables included sow performance, litter performance and livability. Sow body weights and BF thickness were taken at loading (˜d113 of gestation) and weaning (˜d18-22 of lactation). Litter body weights were taken one day after birth and on the day of weaning.

TABLE 2
Description of dietary treatments.

| Treatment | Red beetroot powder Inclusion | |
|---|---|---|
| A | 0 | wt % |
| B | 0.02 | wt % |
| C | 0.2 | wt % |

### Gilts/Sows.

Gilts and sows that were enrolled in this trial were assigned to their treatment and room before entering the lactation barn. Females were loaded into their farrowing crates 4 days before their expected farrowing date. Pre-farrowing, females were fed 6 lb (2.72 kg) of their treatment diets daily then on the day of farrowing, a step up program of feeding was given until 3 days post farrowing when sows were up to ad libitum feeding. The amount of feed added to each feeder was recorded daily. Sows were fed daily according to their assigned treatment and feed weigh backs were done daily to ensure sows had fresh feed. Any feed removed during the lactation period or weighed back after weaning was also recorded. Total lactation feed intake of gilts and sows were calculated.

### Litters.

Litter birth date was determined and recorded on the date a gilt or sow had completed farrowing with complete afterbirth present and piglet umbilical cords were dry or fairly dry. Litter birth weight was done 8 hours following birth to allow for adequate colostrum intake from the birth mother. Litter birth weight measurements were captured on date of birth. If a gilt or sow gave birth to more piglets than she had functional teats, fostering was determined necessary. Piglets may have been cross-fostered to another sow, but only to litters born on the same date and within the same gilt/sow dietary treatment and room. Any piglet(s) fostered to or from a litter were weighed and recorded.

Litter processing was performed 3-5 days after recorded date of birth. Litter processing included shots, tail docking, ear tattooing, and castration of male piglets. Pre-weaning mortality was recorded during the lactation period. Weaning occurred at a minimum of 18 days with a targeted average of 21 days of age, and litter weaning weight was recorded at date of weaning.

Cross fostering was done within the same treatment and same birthdate. Nurse sows were also utilized in this trial. One crate per room was left empty at loading and a newly weaned sow entered the crate on her weaning date. On day 4 after birth of the last litter born, small and unthrifty piglets that would not have survived pre-weaning were removed from the trial and put on the nurse sow.

### Diets.

Diets were formulated to meet or exceed National Research Council (NRC) Nutrient Requirements of Swine, 2012, 11^{th} rev. ed. Washington D.C. National Academies Press. The inclusion of red beetroot powder concentrates were exchanged with corn. Concentrates were produced at Cargill Animal Nutrition (CAN) Lewisburg plant and shipped to the CAN West Branch feed mill. The diets were adjusted to contain 2.5% by weight of the beetroot concentrates for each diet. This was done to reduce the error in adding microamounts of ingredients at West Branch feed mill. Complete diet formulation and expected nutrient composition is shown in Table 3A, and concentrate formulation and expected nutrient composition is shown in Table 3B. Feed samples were taken throughout the trial from each batch of feed and were analyzed via NIR. These results were compared to the expected nutrient composition and summarized in Table 4.

TABLE 3A
Diet formulation.

| RM | | 301500_B | 301500_B1 | 301500_B2 |
|---|---|---|---|---|
| code | Name | CONTROL | 0.02 DOSE | 0.20 DOSE |
| 3_{—} | CORN FINE GROUND BULK | 62.104 | 59.603 | 59.603 |
| 11_{—} | Wheat Midds 27-34% NDF BULK | 11.297 | 11.297 | 11.297 |
| 16_{—} | SOYBEAN HULL BULK | 7.250 | 7.250 | 7.250 |
| 38_{—} | SOYBEAN MEAL HIPRO BULK | 15.000 | 15.000 | 15.000 |
| 42_{—} | SALT BULK | 0.500 | 0.500 | 0.500 |
| 49_{—} | CALCIUM CARBONATE BULK | 1.766 | 1.768 | 1.768 |
| 193_ | MONO-DICAL PHOS BULK | 0.743 | 0.742 | 0.742 |
| 560_ | L-LYSINE HCL | 0.140 | 0.139 | 0.139 |
| 996_ | THREONINE | 0.013 | 0.014 | 0.014 |
| 9275_ | SOYBEAN OIL MIXER BULK | 0.687 | 0.687 | 0.687 |
| 100771_ | SIC STANDARD 10 PHY | 0.500 | 0.500 | 0.500 |
| | (PNA-RSRCH) | | | |
| 101052_ | Conc 1 Beet Root (Research) | 0.000 | 2.500 | 0.000 |
| 101053_ | Conc 2 Beet Root (Research) | 0.000 | 0.000 | 2.500 |

TABLE 3B
Concentrate formulation and expected nutrient composition.

| | | wt % of | | wt % included |
|---|---|---|---|---|
| Sample | Material | concentrate | lbs/ton | in the diet |
| Concentrate 1 | Corn | 99.200 | 49.6 | 2.480 |
| | Beetroot | 0.800 | 0.4 | 0.020 |
| | Total | 100 | 50.0 | 2.500 |
| Concentrate 2 | Corn | 92.000 | 46.0 | 2.300 |
| | Beetroot | 8.000 | 4.0 | 0.200 |
| | Total | 100 | 50.0 | 2.500 |

TABLE 4
Analyzed nitrate levels in the beetroot powder.

| | Nitrate Ion | Nitrogen from nitrate |
|---|---|---|
| Sample | (NO₃): NO₃ (g/kg) | (NO₃N): NO₃N (g/kg) |
| Control feed | 0.26 | 0.06 |
| 0.02% feed | 0.26 | 0.06 |
| 0.2% feed | 0.26 | 0.06 |
| 0.02% concentrate | 0.26 | 0.06 |
| (Concentrate 1) | | |
| 0.2% concentration | 0.44 | 0.1 |
| (Concentrate 2) | | |

### Statistics.

All data were analyzed as a completely randomized block design using appropriate software (R). Analysis of data was performed in accordance with CAN Statistics Standards for Hypothesis testing and Means Separation using Linear and General Linear Models (Revision 1.4, August 2014). Sows having a total born of 7 piglets or less (n=10) or 25 or more (n=3), having 7 or less piglets at them after fostering (n=4), having 7 or more stillborn piglets (n=3), having 5 or more mummies (n=1) or having weaned 5 or less piglets (n=1) were considered an outlier and removed from the analysis. All data analysis were completed using the following model:

Yijkl=μ+αi+βj+αi*βj+Ck+Dl+εijkl

### Where:

Yijkl=A specific trait per experimental unit.
μ=Overall mean
αi=Fixed effect of treatment effect (i=1-3)
βj=Fixed effect of parity class (class 1=parity 1; class 2=parity 2-4; class 3=parity 5+)
αi*βj=The interaction between treatment and Parity class
Ck=Group/block (random effect)
Dl=Days on feed before farrowing (random effect)
εijkl=Error term

Total born was added to the model as a covariable for gestation length, individual and litter birth weight and post farrowing sow weight. The total number of piglets at the sow after fostering were added to the model as a covariable to sow (weight, backfat and feed intake) and piglets (weights) variables measured after fostering or at weaning.

### Results and Discussion

### Data.

Table 5 shows the effect of 0.02 and 0.2 wt % red beetroot powder on technical performance of sows. Table 6 shows the effect of 0.02 and 0.2 wt % red beetroot powder on litter performance. Table 7 shows the effect of 0.02 and 0.2 wt % red beetroot powder on reproductive performance of sows. Table 8 shows the effect between inclusion of red beetroot powder and parity class on technical performance of sows. Table 9 shows the interaction between inclusion of red beetroot powder and parity class on litter performance. Table 10 shows the interaction between inclusion of red beetroot powder and parity class on litter performance.

TABLE 5
Effect of 0.02 and 0.2 wt % red beetroot powder on technical performance of sows.

| | | 0.02% | 0.2% | | |
|---|---|---|---|---|---|
| | | Beetroot | Beetroot | | |
| Variable | Control | powder | powder | SEM | P Trt |
| # Sow | 109 | 104 | 107 | | |
| Average Parity | 4.7 | 4.7 | 4.6 | | |
| Average Lactation Length (d) | 21.4 | 20.4 | 20.6 | | |
| Days on feed before farrowing (d) | 5.5 | 5.3 | 5.2 | | |

Sow Technical Performance

| | | | | | |
|---|---|---|---|---|---|
| Entry Weight (kg) | 234.1 | 234.0 | 234.7 | 3.85 | 0.98 |
| Entry Backfat (mm) | 15.9 | 15.5 | 15.4 | 0.72 | 0.84 |
| Gestation Length (d)¹ | 117.3 | 117.4 | 117.3 | 0.68 | 0.71 |
| Post Farrowing Sow Weight (kg)¹ | 211.9 | 211.8 | 212.0 | 3.60 | 1.00 |
| Sow Wean Weight (kg)² | 212.70 | 210.39 | 210.86 | 3.58 | 0.86 |
| Sow Wean backfat (mm)² | 15.0 | 14.9 | 15.1 | 0.77 | 0.98 |
| Wean to Farrow weight loss (kg)² | 0.56 | −0.69 | 0.13 | 2.42 | 0.91 |
| Relative Wean to Farrow Weight Loss (%)² | −0.02 | −0.25 | 0.04 | 1.12 | 0.97 |
| Wean to Entry Backfat loss (mm)² | −0.92 | −0.54 | −0.39 | 0.34 | 0.32 |
| Wean to Entry Backfat loss (%)² | −5.51 | −2.97 | −1.79 | 2.09 | 0.28 |
| Net post farrowing intake (kg)² | 143.5 | 145.5 | 150.6 | 6.74 | 0.35 |
| ADFI post farrowing (kg)² | 7.1 | 7.3 | 7.4 | 0.20 | 0.31 |

¹Includes Total born piglets as a covariable
²Includes Total piglets after fostering as a covariate

TABLE 6
Effect of 0.02 and 0.2 wt % red beetroot powder on litter performance.

| | | 0.02% | 0.2% | | |
|---|---|---|---|---|---|
| | | Beetroot | Beetroot | | |
| Variable | Control | powder | powder | SEM | P Trt |
| # Sow | 109 | 104 | 107 | | |
| Average Parity | 4.7 | 4.7 | 4.6 | | |
| Average Lactation Length (d) | 21.4 | 20.4 | 20.6 | | |
| Days on feed before farrowing (d) | 5.5 | 5.3 | 5.2 | | |

Piglet Performance

| | | | | | |
|---|---|---|---|---|---|
| Average Litter Birth Weight (kg)¹ | 1.42 | 1.42 | 1.43 | 0.04 | 0.93 |
| Litter Weight Weight (kg)¹ | 19.1 | 19.4 | 19.5 | 0.90 | 0.78 |
| Litter Weight after foster (kg)² | 18.01 | 18.06 | 18.24 | 1.21 | 0.87 |
| Average Litter Weight after foster (kg)² | 1.40 | 1.41 | 1.41 | 0.04 | 0.95 |
| Average Litter Weight (kg)² | 5.86 | 6.12 | 5.98 | 0.19 | 0.27 |
| Litter Weaning Weight (kg)² | 60.32 | 63.32 | 63.98 | 3.15 | 0.18 |
| Litter ADG from foster to weaning (kg/day)² | 2.14 | 2.30 | 2.33 | 0.09 | 0.09 |

¹Includes Total born piglets as a covariable
²Includes Total piglets after fostering as a covariate

TABLE 7
Effect of 0.02 and 0.2 wt % red beetroot powder
on reproductive performance of sows.

| | | | | | |
|---|---|---|---|---|---|
| | | 0.02% | 0.2% | | |
| | | Beetroot | Beetroot | | |
| Variable | Control | Power | Powder | SEM | P Trt |

Sow Reproductive Performance (absolute)

| | | | | | |
|---|---|---|---|---|---|
| Born Alive | 14.3 | 14.4 | 14.8 | — | — |
| Stillborn | 1.4 | 1.3 | 1.1 | — | — |
| Mummified | 0.3 | 0.3 | 0.5 | — | — |
| Total Born | 16.0 | 15.9 | 16.4 | — | — |
| Total Pigs after fostering | 13.0 | 13.2 | 13.5 | — | — |
| Pigs weaned | 10.5 | 10.8 | 11.0 | — | — |

Sow Reproductive Performance (probabilities)

| | | | | | |
|---|---|---|---|---|---|
| Born Alive³ | 90.6 | 90.9 | 91.0 | 1.16 | 0.65 |
| Still Born⁴ | 8.0 | 7.7 | 6.0 | 1.03 | 0.36 |
| Mummified⁵ | 1.4 | 1.4 | 2.9 | 0.58 | 0.30 |
| Pigs Weaned⁶ | 80.4 | 81.3 | 83.0 | 1.62 | 0.49 |
| Pre-weaning Mortality⁷ | 25.3 b | 21.4 ab | 19.5 a | 1.58 | 0.05 |
| Livability⁸ | 69.1 b | 72.4 ab | 76.2 a | 1.72 | 0.03 |

³Calculated as; Born alive/Total born
⁴Calculated as; Still born/Total born
⁵Calculated as; Mummies/Total born
⁶Calculated as; Weaned piglets/Total piglets after fostering
⁷Calculated as; Dead piglets/Born alive + added at fostering − removed at fostering
⁸Calculated as; 1 − ((Dead piglets + Still born)/(Total born + added at fostering − removed at fostering)) *100%

TABLE 8
Interaction between inclusion of red beetroot powder and parity class on technical performance of sows.

| | Control | | | 0.02% Beetroot powder | | | 0.2 Beetroot powder | | | | P Trt* |
|---|---|---|---|---|---|---|---|---|---|---|---|
| Variable | Parity 1 | Parity 2-4 | Parity 5+ | Parity 1 | Parity 2-4 | Parity 5+ | Parity 1 | Parity 2-4 | Parity 5+ | SEM | Parity |
| # Sow | 11 | 42 | 56 | 10 | 40 | 54 | 11 | 44 | 52 | | |
| Average Parity | 1 | 3.2 | 6.6 | 1 | 3.2 | 6.6 | 1 | 3.2 | 6.7 | | |
| Average Lactation | 20 | 20.3 | 20.5 | 20.1 | 20.5 | 20.3 | 19.8 | 20.9 | 20.6 | | |
| Length (d) | | | | | | | | | | | |
| Days on feed before | 6.6 | 5.5 | 5.3 | 6.2 | 5.00 | 5.3 | 6.6 | 4.7 | 5.3 | | |
| farrowing (d) | | | | | | | | | | | |

Sow Technical Performance

| | | | | | | | | | | | |
|---|---|---|---|---|---|---|---|---|---|---|---|
| Entry Weight (kg) | 202.2 | 243.8 | 256.4 | 206.4 | 241.0 | 254.4 | 205.5 | 244.5 | 254.2 | 8.21 | 0.96 |
| Entry B ackfat (mm) | 16.8 | 15.2 | 15.8 | 15.9 | 15.4 | 15.2 | 15.0 | 16.1 | 15.2 | 1.71 | 0.80 |
| Gestation Length (d)¹ | 116.7 | 117.5 | 117.6 | 116.9 | 117.5 | 117.9 | 116.9 | 117.4 | 117.7 | 0.8 | 0.92 |
| Post Farrowing | 183.1 | 218.4 | 234.2 | 186.7 | 216.2 | 232.5 | 185.9 | 217.8 | 232.4 | 7.8 | 0.98 |
| Sow Weight (kg)¹ | | | | | | | | | | | |
| Sow Wean Weight (kg)² | 178.8 | 218.5 | 240.8 | 185.4 | 211.2 | 234.6 | 178.5 | 216.5 | 237.7 | 8.5 | 0.83 |
| Sow Wean backfat (mm)² | 15.2 | 14.5 | 15.4 | 15.8 | 14.0 | 15.0 | 14.8 | 15.3 | 15.2 | 1.8 | 0.86 |
| Wean to Farrow | −4.8 | −0.5 | 6.9 | −0.4 | −4.2 | 2.6 | −5.6 | −1.6 | 7.6 | 5.4 | 0.72 |
| weight loss (kg)² | | | | | | | | | | | |
| Relative Wean to Farrow | −3.2 | 0.0 | 3.1 | −0.4 | −1.8 | 1.4 | −2.7 | −0.7 | 3.5 | 2.5 | 0.67 |
| Weight Loss (%)² | | | | | | | | | | | |
| Wean to Entry Backfat loss | −1.5 | −0.6 | −0.6 | 0.0 | −1.3 | −0.3 | −0.4 | −0.8 | 0.0 | 0.7 | 0.17 |
| (mm)² | | | | | | | | | | | |
| Wean to Entry | −9.9 | −3.2 | −3.4 | −1.0 | −7.6 | −0.3 | −1.4 | −4.6 | 0.7 | 4.6 | 0.20 |
| Backfat loss (%)² | | | | | | | | | | | |
| Net post farrowing | 121.4 | 154.6 | 154.6 | 131.5 | 149.9 | 155.1 | 131.8 | 153.8 | 166.1 | 11.0 | 0.58 |
| intake (kg)² | | | | | | | | | | | |
| ADFI post farrowing (kg)² | 6.0 | 7.7 | 7.7 | 6.5 | 7.5 | 7.8 | 6.5 | 7.7 | 8.1 | 0.4 | 0.55 |

¹ Includes Total born piglets as a covariable
² Includes Total piglets after fostering as a covariate

TABLE 9
Interaction between inclusion of red beetroot powder and parity class on litter performance.

| | Control | | | 0.02% Beetroot powder | | | 0.2 Beetroot powder | | | | P TRT* |
|---|---|---|---|---|---|---|---|---|---|---|---|
| Variable | Parity 1 | Parity 2-4 | Parity 5+ | Parity 1 | Parity 2-4 | Parity 5+ | Parity 1 | Parity 2-4 | Parity 5+ | SEM | Parity |
| # Sow | 11 | 42 | 56 | 10 | 40 | 54 | 11 | 44 | 52 | | |
| Average Parity | 1 | 3.2 | 6.6 | 1 | 3.2 | 6.6 | 1 | 3.2 | 6.7 | | |
| Average Lactation Length | 20 | 20.3 | 20.5 | 20.1 | 20.5 | 20.3 | 19.8 | 20.9 | 20.6 | | |
| (d) | | | | | | | | | | | |
| Days on feed before | 6.6 | 5.5 | 5.3 | 6.2 | 5.00 | 5.3 | 6.6 | 4.7 | 5.3 | | |
| farrowing (d) | | | | | | | | | | | |

Piglet Performance

| | | | | | | | | | | | |
|---|---|---|---|---|---|---|---|---|---|---|---|
| Average Litter Birth Weight | 1.31 | 1.52 | 1.44 | 1.26 | 1.51 | 1.49 | 1.33 | 1.52 | 1.44 | 0.1 | 0.54 |
| (kg)¹ | | | | | | | | | | | |
| Litter Weight Weight (kg)¹ | 17.5 | 20.5 | 19.5 | 17.1 | 21.5 | 19.6 | 18.4 | 20.9 | 19.3 | 1.4 | 0.73 |
| Litter Weight after foster | 17.0 | 19.0 | 18.1 | 16.1 | 19.3 | 18.8 | 17.8 | 19.3 | 17.6 | 1.4 | 0.19 |
| (kg)² | | | | | | | | | | | |
| Average Litter Weight after | 1.3 | 1.5 | 1.4 | 1.3 | 1.5 | 1.5 | 1.4 | 1.5 | 1.4 | 0.1 | 0.17 |
| foster (kg)² | | | | | | | | | | | |
| Average Litter Weight (kg)² | 4.9 | 6.5 | 6.1 | 5.3 | 6.6 | 6.5 | 5.2 | 6.4 | 6.3 | 0.3 | 0.53 |
| Litter Weaning Weight (kg)² | 51.8 | 67.6 | 61.6 | 53.5 | 69.2 | 67.2 | 57.8 | 68.6 | 65.6 | 4.8 | 0.66 |
| Litter ADG from foster to | 1.8 | 2.5 | 2.2 | 1.9 | 2.5 | 2.4 | 2.1 | 2.5 | 2.4 | 0.2 | 0.53 |
| weaning (kg/day)² | | | | | | | | | | | |

¹ Includes Total born piglets as a covariable
² Includes Total piglets after fostering as a covariate

TABLE 10
Interaction between inclusion of red beetroot powder and parity class on litter performance.

| | Control | | | 0.02% Beetroot powder | | | 0.2 Beetroot powder | | | | P TRT* |
|---|---|---|---|---|---|---|---|---|---|---|---|
| Variable | Parity 1 | Parity 2-4 | Parity 5+ | Parity 1 | Parity 2-4 | Parity 5+ | Parity 1 | Parity 2-4 | Parity 5+ | SEM | Parity |

Sow Reproductive Performance (absolute)

| | | | | | | | | | | | |
|---|---|---|---|---|---|---|---|---|---|---|---|
| Born Alive | 13.1 | 14.5 | 14.4 | 13.0 | 15.5 | 13.7 | 13.0 | 15.0 | 15.0 | — | — |
| Stillborn | 0.9 | 1.5 | 1.4 | 1.1 | 0.9 | 1.5 | 0.5 | 1.1 | 1.3 | — | — |
| Mummified | 0.1 | 0.3 | 0.3 | 0.2 | 0.2 | 0.3 | 0.5 | 0.5 | 0.5 | — | — |
| Total Born | 14.1 | 16.4 | 16.2 | 14.3 | 16.6 | 15.6 | 14.0 | 16.7 | 16.8 | — | — |
| Total Pigs after | 12.1 | 13.1 | 13.2 | 12.9 | 14.1 | 12.6 | 12.9 | 14.0 | 13.1 | — | — |
| fostering | | | | | | | | | | | |
| Pigs weaned | 10.2 | 10.7 | 10.4 | 10.4 | 11.2 | 10.5 | 11.1 | 11.4 | 10.6 | — | — |

Sow Reproductive Performance (probabilities)

| | | | | | | | | | | | | | | | | | | | | |
|---|---|---|---|---|---|---|---|---|---|---|---|---|---|---|---|---|---|---|---|---|
| Born Alive³ | 93.1 | ab | 89.0 | ab | 89.2 | ab | 90.3 | ab | 93.6 | b | 88.1 | a | 92.8 | ab | 90.2 | ab | 89.5 | ab | 2.75 | 0.05 |

| | | | | | | | | | | | |
|---|---|---|---|---|---|---|---|---|---|---|---|
| Still Born⁴ | 6.3 | 9.2 | 8.8 | 8.2 | 5.6 | 9.8 | 4.0 | 6.7 | 7.9 | 2.57 | 0.13 |
| Mummified⁵ | 0.6 | 2.0 | 2.0 | 1.4 | 0.9 | 2.1 | 3.0 | 3.1 | 2.7 | 1.37 | 0.37 |
| Pigs Weaned⁶ | 81.4 | 81.1 | 78.6 | 81.1 | 79.5 | 83.2 | 86.2 | 81.0 | 81.5 | 3.72 | 0.32 |
| Pre-weaning | 22.7 | 27.5 | 25.7 | 18.3 | 24.0 | 22.1 | 11.3 | 23.8 | 26.3 | 3.65 | 0.12 |
| Mortality⁷ | | | | | | | | | | | |
| Livability⁸ | 72.8 | 66.2 | 68.2 | 74.9 | 71.5 | 70.8 | 85.6 | 71.7 | 68.5 | 3.94 | 0.08 |

³ Calculated as; Born alive/Total born
⁴ Calculated as; Still born/Total born
⁵ Calculated as; Mummies/Total born
⁶ Calculated as; Weaned piglets/Total piglets after fostering
⁷ Calculated as; Dead piglets/Born alive + added at fostering − removed at fostering
⁸ Calculated as; 1 − ((Dead piglets + Still born)/(Total born + added at fostering − removed at fostering)) *100%

### Feed Analyses.

Nitrate content of the different feeds as well as concentrates were analyzed by using ReflectoQuant and are shown in Table 4. The test is commonly used for water and forage samples. The test used was not sensitive enough to determine the exact nitrate value at the lower levels.

Inclusion of Red Beetroot Powder does not Affect Piglet Birth Weights, but Tended to Increase Litter ADG.

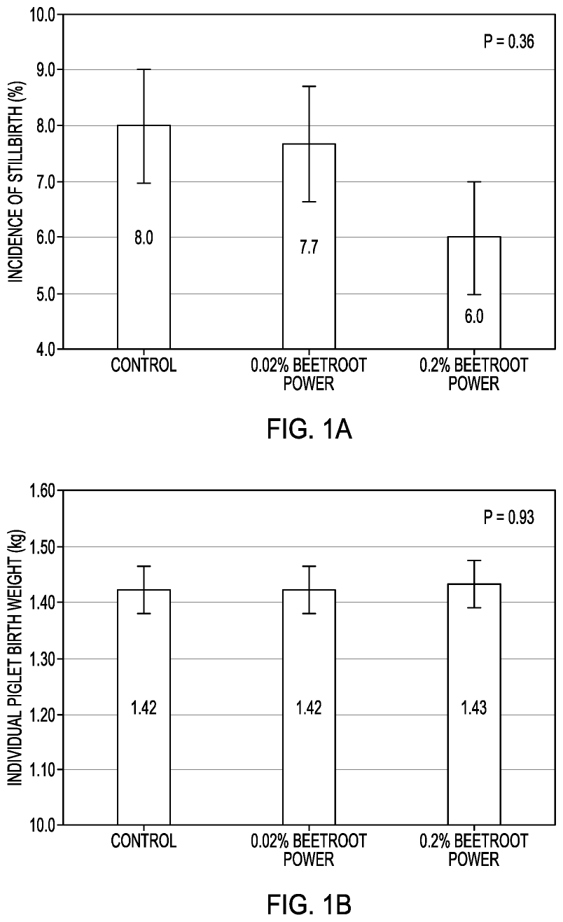

Main parameters of interest of the current trial were piglet birth weights, incidence of stillbirth and incidence of pre-weaning mortality since this are the main parameters that drive piglet livability. Both incidence of stillbirth as well as piglet birth weight were not affected by dosage of red beetroot powder as shown in FIGS. 1A-1B. This is in contrast to the trials done by using calcium nitrate (van den Bosch et al. 2018) which showed an increase of birthweight of 45 grams at the optimal dose compared to the control.

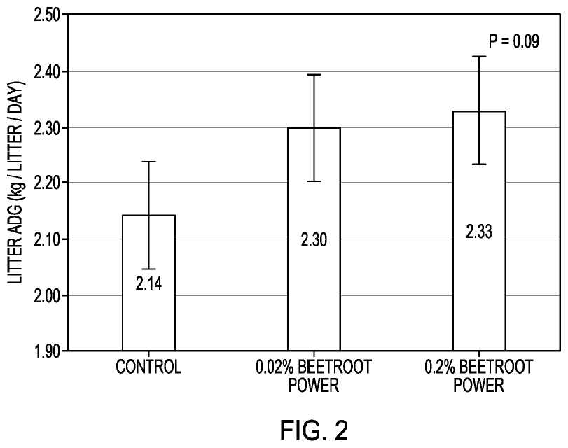

FIG. 2 illustrates the average daily weight gain of the litter for the control and the two levels of beetroot post-fostering weight was included in the statistics models as a covariable. The ADG of piglets post fostering tended to be increased for the treatments containing beetroot at both 0.02 and 0.2 wt % of beetroot powder. This effect was not found in research trials using the calcium nitrate, although some farmers did report heavier weaning weight when using LivaPig® (the brand name of a product sold in Europe containing CaNO₃, Proviox, and enzymes) throughout lactation. The higher ADG could be a result of more vital piglets being born which are more active drinkers and therefore ingest more milk. However, since milk consumption and piglet vitality were not directly measured, this hypothesis cannot be confirmed. The fact that no difference in sow weight loss between treatments is observed does also not suggest this hypothesis is true. A different hypothesis can be that the vasodilative effect of nitrate does not only cause a higher blood flow to the uterus, but also to the mammary glands potentially leading to greater milk production.

### Inclusion of Red Beetroot Powder Decreases Pre-Weaning Mortality and Increases Piglet Livability.

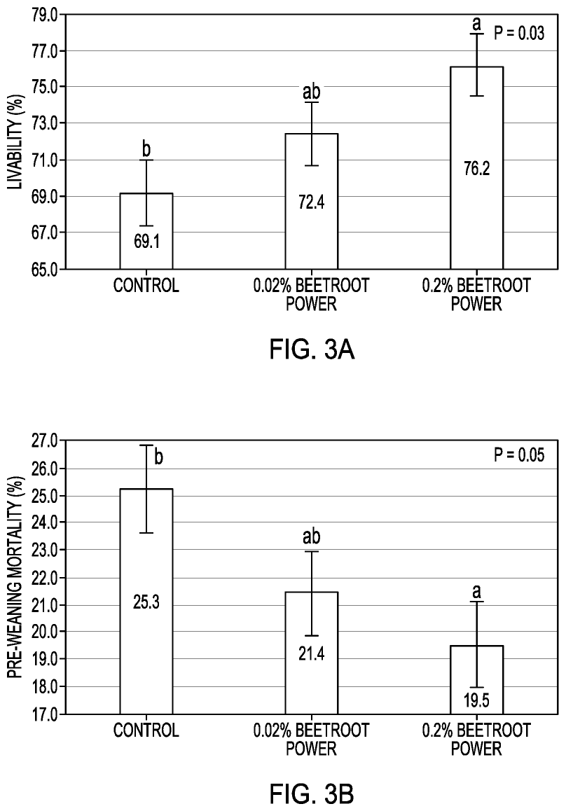

Pre-weaning mortality was significantly reduced with 5.8% when sows received 0.2 wt % red beetroot powder compared to the control (FIG. 3A), leading to a significant increase in livability of 7% (FIG. 3B). Pre-weaning mortality and livability of sows receiving 0.02 wt % of red beetroot did not significantly differ from the control as well as the 0.2 wt % inclusion of red beetroot powder.

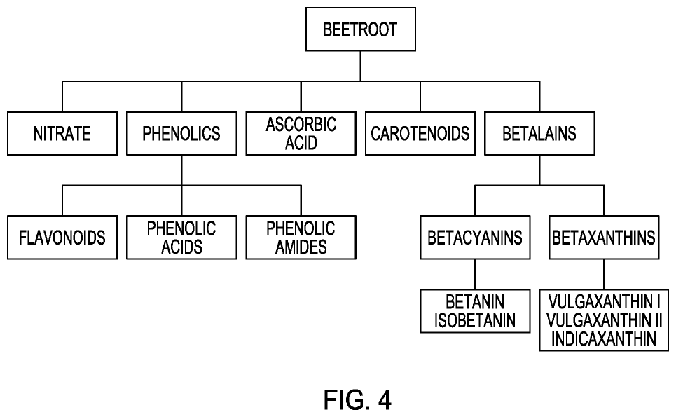

It is striking that the effect of 0.2 wt % beetroot powder on pre-weaning mortality is larger than the effect of 0.19 wt % calcium nitrate on pre-weaning mortality (4.3% vs. a 5.8% reduction in the trial of van den Bosch et al. (2018) and in the current trial respectively), while the active nitrate content used in the current trial is much lower (Table 4). There may be more active components with either a different or additive effect in addition to the nitrate. Beetroot is a rich source of phytochemical compounds (FIG. 4), that includes ascorbic acid, carotenoids, phenolic acids and flavonoids. Beetroot is also one of the few vegetables that contain a group of highly bioactive pigments known as betalains (which give them their red color). Members of the betalain family are categorized as either betacyanin pigments that are red-violet in color or betaxanthin pigments that are yellow-orange in color. Betalains have been reported to have high antioxidant and anti-inflammatory capabilities in vitro and a variety of in vivo animal models. FIG. 4 illustrates various materials in beetroot that might have an additive or interactive effect with nitrate.

Mortality during the current trial was high for average mortality levels on US swine producing farms (˜15%). The euthanisation of piglets and the fact that no distinction can be made between culled and “natural cause of dead” in the data, may have caused the high mortality. However, the culling of piglets was equal among the control and test treatments, so the present results are still an accurate representation of the effect of beetroot powder.

The numerical reduction in pre-weaning mortality compared to the control and the further reduction (significant) at the 0.2 wt % inclusion of beetroot powder suggest a level of beetroot between the 0.02 and 0.2% could also show significant effects at a lower cost. Initial calculations on return on investment (ROI) show that in both the 0.02 and the 0.2 wt % dosage an ROI of higher than 3 is reached, with ROI of 39.8 for 0.02 wt % beetroot inclusion and 6.6 for 0.2 wt % beetroot inclusion.

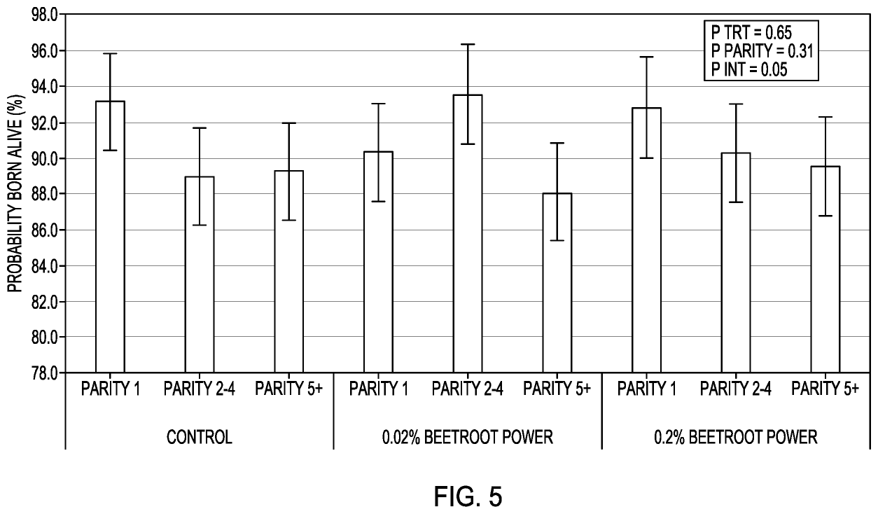

A significant interaction was found between parity class and treatment on probability of piglets being born alive (P=0.05, FIG. 5). In gilts, the control and the 0.2 wt % of beetroot showed the highest probability born alive, while for parity 2-4 sows the highest probability born alive was found when 0.02 wt % of beetroot was fed as seen in FIG. 5. The interaction found, make little biological sense and no explanation could be found why parity 4-6 sows would have a higher probability born alive compared to the same parity class in the control and the 0.2 wt % beetroot treatment.

### Conclusion

0.2 wt % of red beetroot powder added to the lactation diet fed from loading to weaning, significantly decreased pre-weaning mortality with 5.8%, a significantly increased livability with 7.0% and tended to increase litter gain. No significant effect of addition of beetroot was found on the incidence of stillbirth and piglet birth weights. The effects found are larger than what is generally seen with the addition of CaNO₃ (which contains more nitrate) suggesting there are other components in the beetroot powder having an independent or additive effect.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a composition that is an animal feed or a feed product for forming the animal feed, the composition comprising: beetroot powder.

Embodiment 2 provides the composition of Embodiment 1, wherein the beetroot powder is 0.001 wt % to 5 wt % of the animal feed.

Embodiment 3 provides the composition of any one of Embodiments 1-2, wherein the beetroot powder is 0.01 wt % to 0.5 wt % of the animal feed.

Embodiment 4 provides the composition of any one of Embodiments 1-3, wherein the beetroot powder is 0.02 wt % to 0.2 wt % of the animal feed.

Embodiment 5 provides the composition of any one of Embodiments 1-4, wherein the feed product is for forming the animal feed by combining the feed product with a base animal feed to form the animal feed.

Embodiment 6 provides the composition of any one of Embodiments 1-5, wherein the feed product comprises a premix, a concentrate, a base mix, a supplement, a top dress, or a combination thereof.

Embodiment 7 provides the composition of any one of Embodiments 1-6, wherein the animal feed is formulated for use in at least one of a breeding, gestation, or lactation phase of a female animal.

Embodiment 8 provides the composition of Embodiment 7, wherein the animal is a ruminant, pig, avian species, horse, aquaculture animal, companion animal, or wild game.

Embodiment 9 provides the composition of Embodiment 8, wherein the avian species is a chicken, duck, or turkey.

Embodiment 10 provides the composition of any one of Embodiments 1-8, wherein the animal is a pig.

Embodiment 11 provides the composition of any one of Embodiments 1-8 or 10, wherein the animal is a domestic pig, Sus scrofa domesticus.

Embodiment 12 provides the composition of any one of Embodiments 1-8 or 10-11, wherein the animal is a breed of domestic pig comprising Aksai Black Pied, American Yorkshire, Angeln Saddleback, Appalachian English, Arapawa Island, Auckland Island Pig, Australian Yorkshire, Ba Xuyen, Babi Kampung, Bangur Pig, Bantu, Basque, Bazna, Beijing Black, Belarus Black Pied, Belgian Landrace, Bengali Brown Shannaj, Bentheim Black Pied, Berkshire, Bisaro, Black Canarian Pig, Black Slavonian, Breitovo, British Landrace, British Lop, British Saddleback, Bulgarian White, Cantonese, Celtic Pig, Chato Murciano, Chester White, Chiangmai Blackpig, Moodum Chiangmai, Creole Pig, Cumberland Pig, Czech Improved White, Danish Landrace, Danish Protest Pig, Dermantsi Pied, Dharane Kalo Sungur, Duroc, Dutch Landrace Pig, East Balkan Pig, Essex, Estonian Bacon, Fengjing Pig, Finnish Landrance, Forest Mountain, French Landrace, Gascon, German Landrace, Gloucestershire Old Spot, Grice, Guinea Hog, Göttingen Minipig, Hampshire, Hante, Hereford, Hezuo, Hogan Hog, Huntingdon Black Hog, Iberian, Italian Landrace, Japanese Landrace, Jeju Black Pig, Jinhua Pig, Juliana, Kakhetian, Kele Pig, Kemerovo, Korean Native Pig, Krskopolje, Kunekune, Lacombe, Large Black, Large Black-White, Large White, Latvian White, Leicoma, Li Yan Pig, Lincolnshire Curly-Coated Pig, Linderödssvin, Lithuanian Native, Lithuanian White, Livny, Malhado De Alcobaça, Mangalitsa, Meishan, Middle White, Minokawa Buta, Minzhu, Mong Cai, Mora Romagnola, Moura, Mukota, Mulefoot, Murom, Myrhorod, Neijiang, Nero Dei Nebrodi, Ningxiang, North Caucasian, North Siberian, Norwegian Landrace, Norwegian Yorkshire, Ossabaw Island, Oxford Sandy and Black, Pakchong 5, Philippine Native, Piétrain, Poland China, Red Wattle, Semirechensk, Siberian Black Pied, Small Black, Small White, Spots, Surabaya Babi, Swabian-Hall, Swedish Landrace, Taihu Pig, Tamworth, Thuoc Nhieu, Tibetan, Tokyo-X, Tsivilsk, Turopolje, Ukrainian Spotted Steppe, Ukrainian White Steppe, Urzhum, Vietnamese Potbelly, Welsh, Wessex Saddleback, West French White, Windsnyer, Wuzishan, Yanan, Yorkshire Blue and White, or a combination thereof.

Embodiment 13 provides the composition of any one of Embodiments 1-12, wherein the animal feed is a complete feed.

Embodiment 14 provides the composition of any one of Embodiments 1-13, wherein the feed product is formulated to form the animal feed by combining with a base animal feed such that the feed product is 30 wt % or less of the animal feed.

Embodiment 15 provides the composition of any one of Embodiments 1-14, wherein the feed product is formulated to form the animal feed by combining with a base animal feed such that the feed product is 10 wt % or less of the animal feed.

Embodiment 16 provides the composition of any one of Embodiments 1-15, wherein the feed product is formulated to form the animal feed by combining with a base animal feed such that the feed product is 1 wt % to 5 wt % of the feed product.

Embodiment 17 provides the composition of any one of Embodiments 1-16, wherein the composition is a feed product that is a premix, a concentrate, a supplement, a top dress, or a combination thereof.

Embodiment 18 provides the composition of Embodiment 17, wherein the beetroot powder is 0.001 wt % to 30 wt % of the feed product.

Embodiment 19 provides the composition of any one of Embodiments 17-18, wherein the beetroot powder is 0.4 wt % to 15 wt % of the feed product.

Embodiment 20 provides the composition of any one of Embodiments 17-19, wherein the beetroot powder is 0.8 wt % to 10 wt % of the feed product.

Embodiment 21 provides the composition of any one of Embodiments 17-20, wherein the feed product further comprises vitamins, trace minerals, edible plant materials, grain, corn, soy, rice, wheat, or a combination thereof.

Embodiment 22 provides the composition of any one of Embodiments 17-21, wherein the feed product further comprises corn.

Embodiment 23 provides the composition of any one of Embodiments 17-22, wherein the feed product further comprises vitamins and trace minerals.

Embodiment 24 provides the composition of any one of Embodiments 17-23, wherein nitrate in the feed product is 0.01 g/kg to 2.0 g/kg.

Embodiment 25 provides the composition of any one of Embodiments 17-24, wherein nitrate in the feed product is 0.01 g/kg to 1.0 g/kg.

Embodiment 26 provides the composition of any one of Embodiments 17-25, wherein nitrogen from nitrate in the feed product is 0.01 g/kg to 0.5 g/kg.

Embodiment 27 provides the composition of any one of Embodiments 17-26, wherein nitrogen from nitrate in the feed product is 0.01 g/kg to 0.2 g/kg.

Embodiment 28 provides the composition of any one of Embodiments 1-27, wherein nitrate is 0.05 wt % to 3 wt % of the beetroot powder.

Embodiment 29 provides the composition of any one of Embodiments 1-28, wherein nitrate is 0.4 wt % to 1 wt % of the beetroot powder.

Embodiment 30 provides the composition of any one of Embodiments 1-29, wherein nitrate in the animal feed is 0.001 g/kg to 1 g/kg.

Embodiment 31 provides the composition of any one of Embodiments 1-30, wherein nitrate in the animal feed is 0.01 g/kg to 0.5 g/kg.

Embodiment 32 provides the composition of any one of Embodiments 1-31, wherein nitrogen from nitrate in the animal feed is 0.001 g/kg to 0.2 g/kg.

Embodiment 33 provides the composition of any one of Embodiments 1-32, wherein nitrogen from nitrate in the animal feed is 0.01 g/kg to 0.1 g/kg.

Embodiment 34 provides a feed product that is a premix, a base mix, a concentrate, a supplement, or a top dress, for forming an animal feed for at least one of a gestation or lactation phase of a pig, the feed product comprising: beetroot powder that is 0.1 wt % to 30 wt % of the feed product; wherein the feed product is formulated to form the animal feed by combining with a base animal feed such that the feed product is 10 wt % or less of the animal feed.

Embodiment 35 provides an animal feed for use in at least one of a gestation or lactation phase of a pig, the animal feed comprising: a base animal feed; and beetroot power that is 0.001 wt % to 0.5 wt % of the animal feed.

Embodiment 36 provides a method of feeding an animal comprising: feeding the animal beetroot powder.

Embodiment 37 provides the method of Embodiment 36, wherein feeding the animal beetroot powder comprises adding the beetroot powder to animal feed for ingestion by the animal, adding the beetroot powder to water for drinking by the animal, or a combination thereof.

Embodiment 38 provides the method of any one of Embodiments 36-37, wherein feeding the animal beetroot powder comprises feeding the animal an animal feed that is 0.001 wt % to 5 wt % beetroot powder.

Embodiment 39 provides the method of any one of Embodiments 36-38, wherein feeding the animal beetroot powder comprises feeding the animal the animal feed of any one of Embodiments 1-35.

Embodiment 40 provides the method of any one of Embodiments 36-39, wherein the animal is in at least one of a gestation or lactation phase during the feeding.

Embodiment 41 provides the method of any one of Embodiments 36-40, comprising feeding the animal feed to the animal through at least farrowing of the animal.

Embodiment 42 provides the method of any one of Embodiments 36-41, comprising feeding the animal feed after farrowing and before weaning.

Embodiment 43 provides the method of any one of Embodiments 39-42, wherein the animal feed is a daily feed ration that is fed to the animal on most days or on all days.

Embodiment 44 provides the method of any one of Embodiments 36-43, wherein the animal is at least one of a ruminant, pig, avian species, horse, aquaculture animal, companion animal, or wild game.

Embodiment 45 provides the method of any one of Embodiments 36-44, wherein the animal is a pig.

Embodiment 46 provides the method of any one of Embodiments 36-45, wherein the animal is a domestic pig, Sus scrofa domesticus.

Embodiment 47 provides the method of any one of Embodiments 36-46, wherein the animal is a breed of domestic pig comprising Aksai Black Pied, American Yorkshire, Angeln Saddleback, Appalachian English, Arapawa Island, Auckland Island Pig, Australian Yorkshire, Ba Xuyen, Babi Kampung, Bangur Pig, Bantu, Basque, Bazna, Beijing Black, Belarus Black Pied, Belgian Landrace, Bengali Brown Shannaj, Bentheim Black Pied, Berkshire, Bisaro, Black Canarian Pig, Black Slavonian, Breitovo, British Landrace, British Lop, British Saddleback, Bulgarian White, Cantonese, Celtic Pig, Chato Murciano, Chester White, Chiangmai Blackpig, Moodum Chiangmai, Creole Pig, Cumberland Pig, Czech Improved White, Danish Landrace, Danish Protest Pig, Dermantsi Pied, Dharane Kalo Sungur, Duroc, Dutch Landrace Pig, East Balkan Pig, Essex, Estonian Bacon, Fengjing Pig, Finnish Landrance, Forest Mountain, French Landrace, Gascon, German Landrace, Gloucestershire Old Spot, Grice, Guinea Hog, Göttingen Minipig, Hampshire, Hante, Hereford, Hezuo, Hogan Hog, Huntingdon Black Hog, Iberian, Italian Landrace, Japanese Landrace, Jeju Black Pig, Jinhua Pig, Juliana, Kakhetian, Kele Pig, Kemerovo, Korean Native Pig, Krskopolje, Kunekune, Lacombe, Large Black, Large Black-White, Large White, Latvian White, Leicoma, Li Yan Pig, Lincolnshire Curly-Coated Pig, Linderödssvin, Lithuanian Native, Lithuanian White, Livny, Malhado De Alcobaça, Mangalitsa, Meishan, Middle White, Minokawa Buta, Minzhu, Mong Cai, Mora Romagnola, Moura, Mukota, Mulefoot, Murom, Myrhorod, Neijiang, Nero Dei Nebrodi, Ningxiang, North Caucasian, North Siberian, Norwegian Landrace, Norwegian Yorkshire, Ossabaw Island, Oxford Sandy and Black, Pakchong 5, Philippine Native, Piétrain, Poland China, Red Wattle, Semirechensk, Siberian Black Pied, Small Black, Small White, Spots, Surabaya Babi, Swabian-Hall, Swedish Landrace, Taihu Pig, Tamworth, Thuoc Nhieu, Tibetan, Tokyo-X, Tsivilsk, Turopolje, Ukrainian Spotted Steppe, Ukrainian White Steppe, Urzhum, Vietnamese Potbelly, Welsh, Wessex Saddleback, West French White, Windsnyer, Wuzishan, Yanan, Yorkshire Blue and White, or a combination thereof.

Embodiment 48 provides the method of any one of Embodiments 36-47, wherein the method increases vasodilation of at least one of the placenta and the mammary glands of the animal.

Embodiment 49 provides the method of Embodiment 48, wherein the vasodilation of the placenta increases nutrients and oxygen to the placenta, thereby increasing nutrients and oxygen to a fetus of the animal and supporting uterine contractions to help reduce animal fatigue and farrowing time.

Embodiment 50 provides the method of any one of Embodiments 48-49, wherein the vasodilation of the mammary glands of the animal increases milk production of the animal.

Embodiment 51 provides the method of any one of Embodiments 36-50, wherein the method decreases pre-weaning mortality of offspring of the animal, calculated as (dead offspring/(offspring born alive+added at fostering−removed at fostering))*100%, as compared to a corresponding method using animal feed that includes less or none of the beetroot powder.

Embodiment 52 provides the method of Embodiment 51, wherein the method decreases pre-weaning mortality by 1% to 20%.

Embodiment 53 provides the method of any one of Embodiments 51-52, wherein the method decreases pre-weaning mortality by 2% to 10%.

Embodiment 54 provides the method of any one of Embodiments 36-53, wherein the method increases livability of offspring of the animal, calculated as 1−((dead offspring+stillborn offspring)/(total offspring born+added at fostering−removed at fostering))*100%, as compared to a corresponding method using animal feed that includes less or none of the beetroot powder.

Embodiment 55 provides the method of Embodiment 54, wherein the method increases livability of offspring of the animal by 1% to 20%.

Embodiment 56 provides the method of any one of Embodiments 54-55, wherein the method increases livability of offspring of the animal by 3 to 15%.

Embodiment 57 provides the method of any one of Embodiments 36-56, wherein the method increases average daily weight gain of an offspring of the animal, as compared to a corresponding method using animal feed that includes less or none of the beetroot powder.

Embodiment 58 provides the method of Embodiment 57, wherein the method increases average daily weight gain by 1% to 30%.

Embodiment 59 provides the method of any one of Embodiments 57-58, wherein the method increases average daily weight gain 5% to 15%.

Embodiment 60 provides the method of any one of Embodiments 36-59, wherein the method decreases the number of stillborn offspring of the animal, as compared to a corresponding method using animal feed that includes less or none of the beetroot powder.

Embodiment 61 provides the method of Embodiment 60, wherein the method decreases the average number of stillborn offspring by 0.1% to 8%.

Embodiment 62 provides the method of any one of Embodiments 60-61, wherein the method decreases the average number of stillborn offspring by 0.5% to 4%.

Embodiment 63 provides the method of any one of Embodiments 36-62, wherein the method increases average weight at weaning of an offspring of the animal, as compared to a corresponding method using animal feed that includes less or none of the beetroot powder.

Embodiment 64 provides the method of any one of Embodiments 36-63, wherein the method further comprises combining the feed product of any one of Embodiments 1-35 with a base animal feed to form the animal feed.

Embodiment 65 provides a method of feeding a pig comprising:

feeding the pig an animal feed during at least one of a gestation or lactation phase of the animal, the animal feed comprising

a base animal feed, and

beetroot powder, wherein the beetroot powder is 0.001 wt % to 5 wt % of the animal feed;

wherein the method decreases pre-weaning mortality of an offspring of the animal, increases livability of an offspring of the animal, increases daily average weight gain of an offspring of the animal, decreases the number of stillborn offspring of the animal, or a combination thereof, as compared to a corresponding method using animal feed that includes less or none of the beetroot powder.

Embodiment 66 provides a method of making the animal feed of any one of Embodiments 1-35, the method comprising:

combining the feed product of any one of Embodiments 1-35 with a base animal feed, to form the animal feed of any one of Embodiments 1-35.

Embodiment 67 provides a method of making an animal feed, the method comprising:

combining a feed product with a base animal feed, to form an animal feed;

wherein the feed product comprises beetroot powder that is about 0.001 wt % to 30 wt % of the feed product; and

wherein the beetroot powder is 0.001 wt % to 5 wt % of the animal feed.

Embodiment 68 provides the composition or method of any one or any combination of Embodiments 1-67 optionally configured such that all elements or options recited are available to use or select from.

1. A composition that is an animal feed or a feed product for forming the animal feed, the composition comprising:
beetroot powder, wherein the beetroot powder is 0.001 wt % to 5 wt % of the animal feed.

2. The composition of claim 1, wherein the beetroot powder is 0.02 wt % to 0.2 wt % of the animal feed.

3. The composition of claim 1, wherein the feed product comprises a premix, a concentrate, a base mix, a supplement, a top dress, or a combination thereof.

4. The composition of claim 1, wherein the animal feed is formulated for use in at least one of a breeding, gestation, or lactation phase of a female animal.

5. The composition of claim 4, wherein the animal is a ruminant, pig, avian species, horse, aquaculture animal, companion animal, or wild game.

6. The composition of claim 1, wherein the animal is a pig.

7. The composition of claim 1, wherein the animal feed is a complete feed.

8. The composition of claim 1, wherein the feed product is formulated to form the animal feed by combining with a base animal feed such that the feed product is 30 wt % or less of the animal feed.

9. The composition of claim 1, wherein the feed product is formulated to form the animal feed by combining with a base animal feed such that the feed product is 1 wt % to 5 wt % of the feed product.

10. The composition of claim 1, wherein the composition is a feed product that is a premix, a concentrate, a supplement, a top dress, or a combination thereof.

11. The composition of claim 10, wherein the beetroot powder is 0.001 wt % to 30 wt % of the feed product.

12. The composition of claim 10, wherein the beetroot powder is 0.8 wt % to 10 wt % of the feed product.

13. A feed product that is a premix, a base mix, a concentrate, a supplement, or a top dress, for forming an animal feed for at least one of a gestation or lactation phase of a pig, the feed product comprising:
beetroot powder that is 0.1 wt % to 30 wt % of the feed product;
wherein the feed product is formulated to form the animal feed by combining with a base animal feed such that the feed product is 10 wt % or less of the animal feed.

14. An animal feed for use in at least one of a gestation or lactation phase of a pig, the animal feed comprising:
a base animal feed; and
beetroot power that is 0.001 wt % to 0.5 wt % of the animal feed.

15. A method of feeding an animal comprising:
feeding the animal the animal feed of claim 1.

16. The method of claim 15, wherein the animal is in at least one of a breeding, gestation, or lactation phase during the feeding.

17. The method of claim 15, wherein the animal feed is a daily feed ration that is fed to the animal on most days or on all days.

18. The method of claim 15, wherein the animal is at least one of a ruminant, pig, avian species, horse, aquaculture animal, companion animal, or wild game.

19. A method of feeding a pig the animal feed of claim 1, the method comprising:
feeding the pig the animal feed of claim 1 during at least one of a gestation or lactation phase of the animal;
wherein the method decreases pre-weaning mortality of an offspring of the animal, increases livability of an offspring of the animal, increases daily average weight gain of an offspring of the animal, decreases the number of stillborn offspring of the animal, or a combination thereof, as compared to a corresponding method using animal feed that includes less or none of the beetroot powder.

20. A method of making the animal feed of claim 1, the method comprising:
combining the feed product of claim 1 with a base animal feed, to form the animal feed of claim 1.
